(19) United States
(12) Patent Application Publication
(10) Pub. No.: US 2002/0097988 A1
(43) Pub. Date: Jul. 25, 2002

(54) Recording medium with content stream data recorded thereon, recording apparatus, and reproducing apparatus therefor

(76) Inventors: Bum-Sik Yoon, Gyeonggi-do (KR); Sung-wook Park, Seoul (KR)

Correspondence Address: STAAS & HALSEY LLP, 700 11TH STREET, NW, SUITE 500, WASHINGTON, DC, 20001, US

(21) Appl. No.: 10/041,761

(22) Filed: Jan. 10, 2002

Related U.S. Application Data
(60) Provisional application No. 60/262,105, filed on Jan. 18, 2001.

(30) Foreign Application Priority Data
Jan. 10, 2001 (KR) 2001-1234

(51) Int. Cl. H04N 5/781; H04N 7/12; H04N 11/02; H04N 11/04

(52) U.S. Cl. 386/98; 386/125; 386/126; 348/423.1

(57) ABSTRACT

A recording medium having content stream data recorded thereon and a recording and reproducing apparatus provided thereof. On the recording medium, content stream data is recorded as a Stream OBject (SOB) formed with at least one Stream OBject Unit (SOBU), each of which has a predetermined size and one or more stream packs. Each of the stream packs has an Application Time Stamp (ATS) indicating reproducing time information and an application packet in which content stream data is packed therein. Each of the SOBUs, excluding a last one of the SOBUs and SOBUs having stuffing packets, includes at least two entire ATSs. Thus, an incremental application packet arrival time (IAPAT) of each of the SOBUs can be correctly obtained, and program searching referring to a mapping list is smoothly performed without error.

### CROSS-REFERENCE TO RELATED APPLICATIONS

This application claims the benefit of Korean Application No. 2001-1234, filed Jan. 10, 2001 in the Korean Industrial Property Office, and U.S. Provisional Application No. 60/262,105, filed Jan. 18, 2001, the disclosures of which are incorporated herein by reference.

### BACKGROUND OF THE INVENTION

1. Field of the Invention

The present invention relates to recording and reproducing content stream data, and more particularly, to a recording medium with content stream data recorded thereon, wherein a recording apparatus and a reproducing apparatus is provided therefor.

2. Description of the Related Art

A single piece of any of various forms of content, such as, for example, a movie, a music track, etc., is referred to as a program in the present invention.

FIG. 1 shows the conventional data structure of a program.

Generally, content stream data of a program is formed by one stream object (SOB). Referring now to FIG. 1, an SOB is formed of a chain in which one or more Stream Object Units (SOBUs) are linked. SOBUs are units in which data is recorded and edited. However, since the input and/or output speeds of data streams of a program may change in recording and/or reproducing, the corresponding SOBU lengths on a time axis may differ from one another. An SOBU includes a plurality of stream packs. SOBUs included in the same SOB include the same number of stream packs.

A stream pack is formed by a pack header and a stream packet. A stream packet contains one or more application packets (AP_PKTs). An application packet is a piece of a bit stream which is input when a recording apparatus records data, or output when a reproducing apparatus reproduces data. Therefore, in front of the application packet, an Application Time Stamp (ATS) is located. An ATS reproduces time information of the application packet following the ATS. The start and end of an application packet may not match the start and end of the stream pack. That is, for example, an application packet may stretch over a boundary between two stream packs (i.e., two neighboring SOBUs).

To arbitrarily access a program recorded as shown in FIG. 1, search information is generally used. Search information may include information on a location of certain data in a program, program reproducing time information, and program recording time information. Search information may have various formats depending on application fields. However, to reduce an amount of information and enable a quick search, a hierarchical structure is frequently used to indicate data location in the program.

If search information of a program is formed of three layers, like, for example a cell layer, an SOB layer, and an SOBU layer, the search information includes information on which cell or cells correspond to a given program, information on which SOB or SOBs correspond to a given cell, and information on which SOBU or SOBUs correspond to a given SOB. Particularly, information on which SOBU or SOBUs correspond to a given SOB is referred to as a MAPping List (MAPL).

A mapping list contains an incremental application packet arrival time (IAPAT) which indicates a duration of a corresponding SOBU. The arrival time of an application packet contained in the corresponding SOBU is needed for obtaining an IAPAT.

A size of an application packet (AP_PKT_SZ) satisfies the following equation: AP_PKT_SZ≦2018×{SOBU_SZ}−2.

SOBU_SZ denotes a size of an SOBU. The above expression is made considering that at least 30 bytes are needed for a pack header, and 2 bytes are needed for a header extension and a stuffing packet defined in a stream packet, assuming that one SOBU has a number of stream packs equal to the number of SOBU_SZs. This is due to the maximum area for application packets being the result obtained by subtracting 30 bytes from 2048 bytes for one SOBU and then again subtracting 2 bytes from the resulting 2018 bytes.

However, according to the above scope of the size of an application packet, a case occurs where there is no ATS in an SOBU.

FIG. 2 illustrates a case where there is no application time stamp (ATS) in a stream object unit (SOBU).

Referring now to FIG. 2, if a last stream pack contained in an SOB is located as shown in FIG. 2, a first byte forming an ATS is not included in SOBU #M−1. Since only a part of an application packet formed in the last stream pack is located in SOBU #M, there is no ATS in SOBU #M.

Thus, according to the size of the application packet described above, a case may occur where there is no corresponding ATS, such as in SOBU #M−1 or SOBU #M. An IAPAT of an SOBU which has no corresponding ATS may not be obtained, and therefore, a mapping list formed of the IAPAT as search information is not be obtained. Accordingly, searching a program is impossible.

Particularly, in a case where a last SOBU of an SOB does not have a corresponding ATS, an IAPAT is obtained using a copy of the ATS of a last application packet. However, according to a rule for obtaining an IAPAT, both IAPAT(M−1), which is the IAPAT value of SOBU #M−1, and IAPAT(M), which is the IAPAT value of SOBU#M, are “0”. Therefore, a program search based on a mapping list formed of IAPAT is not carried out correctly.

IAPAT(i) should meet the following conditions:

1≦IAPAT(i)≦2¹², i=1

1≦IAPAT(i)≦2¹²−1, 1≦i≦M

0≦IAPAT(i)≦2¹²−1, i=M

FIG. 3 illustrates a conventional method for obtaining IAPAT in a case where there is no ATS included in the last SOBU of an SOB.

Referring now to FIG. 3, if IAPAT(M−1) is “0,” it and does not satisfy the above conditions.

### SUMMARY OF THE INVENTION

Accordingly, it is an object of the present invention to provide a recording medium with content stream data recorded thereon, the content stream data having a data structure in which a stream object unit (SOBU) included in a stream object (SOB) has a corresponding application time stamp (ATS) so that a program search based on a mapping list is correctly performed. A recording and reproducing apparatus is provided therefor the recording.

Additional objects and advantages of the invention will be set forth in part in the description which follows and, in part, will be obvious from the description, or may be learned by practice of the invention.

The foregoing and other objects of the present invention are achieved by providing a recording medium on which content stream data is recorded including a Stream OBject (SOB) formed with at least one Stream OBject Unit (SOBU) which has a predetermined size and one or more stream packs. Each of the stream packs has an Application Time Stamp (ATS) indicating reproducing time information and an application packet in which content stream data is packed. Each of the SOBUs, excluding a last SOBU and SOBUs having stuffing packets, includes at least two entire ATSs.

According to an aspect of the invention, a size of the application packet is small enough so that the SOBU excluding the last SOBU and SOBUs having stuffing packets may include at least two entire ATSs.

According to an aspect of the invention, the size of the application packet satisfies the following equation:

AP_{—}PKT_{—}SZ≦SPayload_{—}SZ×{SOBU_{—}SZ/2}−{cell((N_{—}AHE+N_{—}SByte)/2)+ATS_{—}SZ},

where AP_PKT_SZ denotes the size of the application packet, ATS_SZ denotes a size of an ATS which is formed in units of bytes, SOBU_SZ denotes a size of an SOBU, SPayload_SZ denotes a size of data space containing information excluding a fixed header area of a stream pack, N_AHE denotes a number of application header extensions of a corresponding SOBU, and N_SByte denotes a number of stuffing bytes of a corresponding SOBU.

According to an aspect of the invention, the size of the application packet satisfies the following equation:

AP_{—}PKT_{—}SZ≦2018×{SOBU_{—}SZ}−6

where AP_PKT_SZ denotes the size of the application packet and SOBU_SZ denotes the size of the SOBU.

According to yet another aspect of the invention, a MAPping List (MAPL) having an Incremental Application Packet Arrival Time (IAPAT) indicating a duration of the corresponding SOBU is further included as search information indicating which of the SOBUs are included in a corresponding SOB.

The foregoing and other objects of the present invention are also achieved by providing a recording medium on which content stream data is recorded according to another embodiment of the invention that includes a Stream OBject (SOB) formed with at least one Stream OBject Unit (SOBU) which has a predetermined size and one or more stream packs. Each of the stream packs having an Application Time Stamp (ATS) indicating reproducing time information and an application packet in which content stream data is packed. Each of the SOBUs, excluding a last SOBU and SOBUs having stuffing packets, includes at least two entire ATSs. Each of the SOBUs has stuffing packets for correction includes a predetermined ATS.

According to an aspect of the invention, the stuffing packets for correction are recorded continuously after a last application packet included in the SOB.

According to an aspect of the invention, the predetermined ATS included in the stuffing packet for correction has a same value as an ATS included in the last stream pack.

According to a yet additional aspect of the invention, the stuffing packet for correction further includes a payload in which predetermined data is recorded or no data is recorded.

According to a further aspect, a “0” is recorded in the payload.

According to a still further aspect, the size of the application packet is small enough so that each of the SOBUs, excluding the last SOBU, includes at least two entire ATS.

According to a yet still further aspect, the size of the application packet satisfies the following equation:

AP_{—}PKT_{—}SZ≦SPayload_{—}SZ×{SOBU_{—}SZ/2}−{cell((N_{—}AHE+N_{—}SByte)/2)+ATS_{—}SZ},

where AP_PKT_SZ denotes the size of the application packet, ATS_SZ denotes a size of an ATS which is formed in units of bytes, SOBU_SZ denotes a size of an SOBU, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

According to another aspect, a MAPping List (MAPL) having an Incremental Application Packet Arrival Time (IAPAT) indicating a duration of the corresponding SOBU is further included as search information indicating which of the SOBUs are included in a corresponding SOB.

The foregoing and other objects of the present invention are also achieved by providing a recording apparatus recording content stream data as a Stream OBject (SOB) formed with at least one Stream OBject Unit (SOBU) having a predetermined size according to a further embodiment of the invention. The recording apparatus includes a control unit which generates a mapping list as search information, a clock generation unit which generates a clock value, and a buffer unit which attaches the clock value provided from the clock generating unit to received content stream data, and outputs the received content stream data by buffering the content stream data. The apparatus also includes a stream object unit (SOBU) generating unit which packs the received content stream data output from the buffer unit and generates SOBUs so that each of the SOBUs, excluding a last SOBU, contains at least two entire Application Time Stamps (ATSs). The apparatus also includes a recording unit which records the SOBUs generated by the SOBU generating unit and the mapping list generated by the control unit.

According to an aspect of the invention, the size of the application packet is small enough so that each of the SOBUs, excluding the last SOBU, includes at least two entire ATSs.

According to an aspect of the invention, the size of the application packet satisfies the following equation:

AP_{—}PKT_{—}SZ≦SPayload_{—}SZ×{SOBU_{—}SZ/2}−{cell((N_{—}AHE+N_{—}SByte)/2)+A TS_{—}SZ},

where AP_PKT_SZ denotes the size of the application packet, ATS_SZ denotes a size of an ATS which is formed in units of bytes, SOBU_SZ denotes a size of an SOBU, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

According to still another aspect, a MAPping List (MAPL) having an Incremental Application Packet Arrival Time (IAPAT) indicating a duration of the corresponding SOBU is further included as search information indicating which of the SOBUs are included in a corresponding SOB.

The foregoing and other objects of the present invention are also achieved by providing a recording apparatus recording content stream data as a Stream OBject (SOB) formed with at least one Stream OBject Unit (SOBU) having a predetermined size according to a still further embodiment of the invention. The recording apparatus includes a control unit which generates a mapping list as search information, a clock generation unit which generates a clock value, and a buffer unit attaching the clock value provided from the clock generating unit to received content stream data, and outputting the received content stream data by buffering the content stream data. The apparatus also includes a stream object unit (SOBU) generating unit which includes a stuffing packet for correction having a predetermined Application Time Stamp (ATS) which has a value the same as an ATS among ATSs included in an SOBU located immediately before an SOBU having no corresponding ATS. The apparatus also includes a recording unit which records the SOBUs generated by the SOBU generating unit and the mapping list generated by the control unit.

According to an aspect, all SOBUs excluding a last SOBU contain at least two entire ATSs, the SOBU generating unit includes a stuffing packet for correction in the last SOBU, and the recording unit continuously records the stuffing packet after a last application packet included in the SOB.

According to a further aspect, an ATS included in the stuffing packet for correction has the same value as an ATS contained in a last stream pack. The stuffing packet for correction further includes a payload in which predetermined data is recorded, or no data is recorded.

According to a still further aspect, the recording unit records “0” in the payload.

The foregoing and other objects of the present invention are also achieved by providing a recording apparatus recording an SOB having one or more SOBUs each of which has one or more stream packs standing in a row and are divided into units of a predetermined size and sequentially assigned according to an additional embodiment of the invention. Each of the stream packs includes an application time stamp (ATS) and an application packet (A_PKT) having content stream data. The recording apparatus has a clock generation unit generating a clock value and a buffer unit attaching the clock value provided from the clock generating unit to received content stream data, and outputting the received content stream data by buffering the content stream data. The recording apparatus also includes an SOBU generating unit generating SOBUs by packing content stream data output from the buffer unit, a control unit generating a mapping list as search information by regarding a last SOBU, which has no corresponding ATS as having a virtual ATS, and a recording unit recording the SOBUs generated by the SOBU generating unit and the mapping list generated by the control unit.

According to an aspect of the invention, the control unit generates a mapping list having an IAPAT obtained by regarding a last application packet included in the SOB as having a virtual ATS.

According to an aspect of the invention, the size of the application packet is small enough to include at least two entire ATSs and satisfies the following expression:

AP_{—}PKT_{—}SZ≦SPayload_{—}SZ×{SOBU_{—}SZ/2}−{cell((N_{—}AHE+N_{—}SByte)/2)+ATS_{—}SZ}.

where AP_PKT_SZ denotes the size of the application packet, SOBU_SZ denotes the size of an SOBU, ATS_SZ denotes a byte size of an ATS, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

The foregoing and other objects of the present invention are also achieved by providing a reproducing apparatus reproducing content stream data from a recording medium on which content stream data is recorded as an SOB formed with at least one SOBU having a predetermined size according to a yet additional embodiment of the invention. Each SOBU has at least one stream pack, which includes an ATS indicating reproducing time information and an application packet in which content stream data is packed. Each SOBU excluding a last SOBU and SOBUs having stuffing packets, includes at least two entire ATSs. A mapping list having search information on an SOBU regards the last SOBU as an SOBU having a virtual ATS. The reproducing apparatus also has a reading unit that reads the mapping list as search information and the SOBU, a control unit that controls the reading unit so as to read a corresponding SOBU, referring to the mapping list read by the reading unit, a clock generating unit that generates a clock value, and an SOBU analyzing unit that extracts content stream data by analyzing the SOBU read by the reading unit. A buffer unit that outputs the content stream data is provided from the SOBU analyzing unit by buffering the content stream data based on a clock value provided by the clock generating unit.

According to an aspect of the invention, the size of the application packet is small enough to include at least two entire ATSs and satisfies the following expression:

AP_{—}PKT_{—}SZ≦SPayload_{—}SZ×{SOBU_{—}SZ/2}−{cell((N_{—}AHE+N_{—}SByte)/2)+ATS_{—}SZ}.

where AP_PKT_SZ denotes the size of the application packet, SOBU_SZ denotes the size of an SOBU, ATS_SZ denotes a byte size of an ATS, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

According to another aspect of the invention, the mapping list includes an incremental application packet arrival time (IAPAT) indicating a duration of a corresponding SOBU as search information indicating the corresponding SOBU of a corresponding SOB.

The foregoing and other objects of the present invention are also achieved by providing a reproducing apparatus reproducing content stream data from a recording medium on which content stream data is recorded as an SOB formed with at least one SOBU having a predetermined size according to still yet another embodiment of the present invention. The SOBU has one or more stream packs, each of which includes an ATS indicating reproducing time information and an application packet in which content stream data is packed. Each SOBU excluding a last SOBU and SOBUs having stuffing packets, includes at least two entire ATSs, and the last SOBU contains a stuffing packet for correction having a predetermined ATS. The reproducing apparatus also has a reading unit to read the mapping list as search information and the SOBU a control unit to control the reading unit so as to read a corresponding SOBU, referring to the mapping list read by the reading unit, a clock generating unit to generate a clock value, and an SOBU analyzing unit to extract content stream data by analyzing the SOBU read by the reading unit. A buffer unit that outputs the content stream data is provided from the SOBU analyzing unit by buffering the content stream data based on a clock value provided by the clock generating unit.

According to an aspect of the invention, the predetermined ATS contained in the stuffing packet for correction has the same value as the ATS contained in the last stream pack. The stuffing packet for correction further includes a payload in which predetermined data is recorded, or no data is recorded.

### BRIEF DESCRIPTION OF THE DRAWINGS

These and other objects and advantages of the invention will become apparent and more appreciated from the following description of the preferred embodiments, taken in conjunction with the accompanying drawings of which:

FIG. 1 shows the conventional data structure of a program;

FIG. 2 illustrates a case where there is no ATS in an SOBU;

FIG. 3 illustrates a conventional method for obtaining an IAPAT in a case where there is no ATS in the last SOBU of an SOB;

FIG. 4 is a data structure, according to an embodiment of the present invention;

FIG. 5 is a data structure, according to an embodiment of the present invention;

FIG. 6 is a block diagram of a recording apparatus, according to an embodiment of the present invention;

FIG. 7 is a block diagram of a reproducing apparatus, according to an embodiment of the present invention; and

FIG. 8 is a block diagram of a recording and reproducing apparatus, according to an embodiment of the present invention.

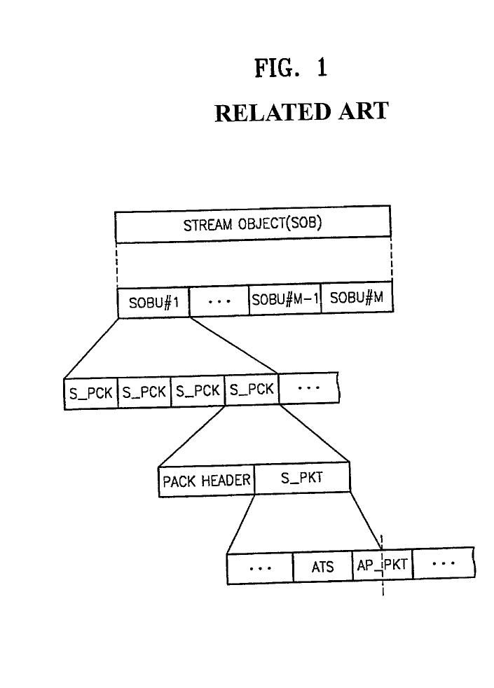

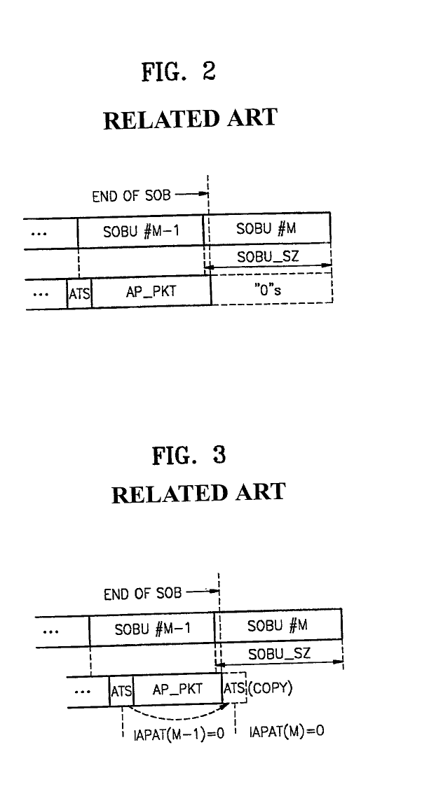

### DETAILED DESCRIPTION OF THE PREFERRED EMBODIMENTS

Reference will now be made in detail to the present preferred embodiments of the present invention, examples of which are illustrated in the accompanying drawings, wherein like reference numerals to like elements throughout.

A recording medium according to the present invention is a rewritable recording medium in which a user records and edits a program formed of content stream data. Recording content stream data means to record input content stream data without encoding. That is, for example, audio or video stream data such as music or movies is received, buffered, packed in predetermined units, and recorded on the recording medium.

Digital Versatile Disc-Stream Recording (DVD-SR), which is a recording medium according to the present invention, includes a program recorded in the form of a stream object (SOB), and search information for program navigation.

Here, as in the prior art, the SOB means a program, such as music or a movie, which is recorded in the form of content stream data, and includes one or more stream packs (S_PCKs). Stream packs standing in a row are divided so that each divided unit has an identical predetermined size and the resulting divided unit is a stream object unit (SOBU). Therefore, an SOBU may contain a plurality of stream packs, but the start or end of a first or a last stream pack may not match the start or end of the SOBU. That is, for example, a stream pack may stretch across a boundary between two SOBUs.

A stream pack is formed by a pack header and a stream packet. A stream packet contains one or more application packets (AP_PKTs). An application packet (AP_PKT) is a piece of a bit stream which is input when a recording apparatus records data, or output when a reproducing apparatus reproduces data. Thus, in front of an application packet, a time stamp (ATS) is located. An ATS is reproducing time information of the application packet located immediately behind the ATS.

Further, there is provided search information having a hierarchical structure and includes information on which cells correspond to a predetermined program, an SOB corresponds to a predetermined cell, and SOBUs correspond to a predetermined SOB. Particularly, information on which SOBUs correspond to an SOB is referred to as a mapping list (MAPL). The mapping list contains an incremental application packet arrival time (IAPAT) indicating a duration of a corresponding SOBU. A rule for obtaining an IAPAT will be explained later.

Each of the SOBUs, excluding a last SOBU, contained in a SOB according to the present invention, has at least two entire ATSs. That is, for example, the first byte of each of at least two ATSs is contained in a corresponding SOBU. Hence, a size of an application packet according to the present invention satisfies the following expression:

AP_{—}PKT_{—}SZ≦SPayload_{—}SZ×{SOBU_{—}SZ/2}−{cell((N_AHE+N_{—}SByte)/2)+ATS_{—}SZ}

where AP_PKT_SZ denotes a size of an application packet, SOBU_SZ denotes a size of an SOBU, ATS_SZ denotes a byte size of an ATS, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

However, an exception to the expression above is an SOBU containing a stuffing packet. Here, the stuffing packet is packet data which is inserted to prevent an overflow of an IAPAT when an SOBU is not filled with application packets, even in a maximum duration that is expressed by an IAPAT at a low bit rate. The stuffing packet has no relation with the content, and is used for timing regeneration needed in reproducing.

The above expression may also be simplified when it is applied to a special case as follows. That is, for example, considering that at least 30 bytes are needed for a pack header and 2 bytes are needed for a header extension and a stuffing packet defined in a stream packet, assuming that one SOBU has a number of stream packs equal to the number of SOBU_SZs, 2018×{SOBU_SZ}−2 is the remaining area.

Here, 2018 represents the size of data space (SPayload_SZ) containing information excluding the size of fixed header area in a stream pack of 2048 bytes. However, if a size of an ATS is 4 bytes, a size of an application packet is made to be less than or equal to 2018×−6 so that each of the SOBUs, excluding the SOBUs containing stuffing packets and the last SOBU, contains the first byte of each of at least two ATSs. Therefore, the above expression is simplified as the following expressions:

(AP_{—}PKT_{—}SZ+4)×2≦2018×{SOBU_{—}SZ}−2×2

AP_{—}PKT_{—}SZ≦2018×{SOBU_{—}SZ/2}−6

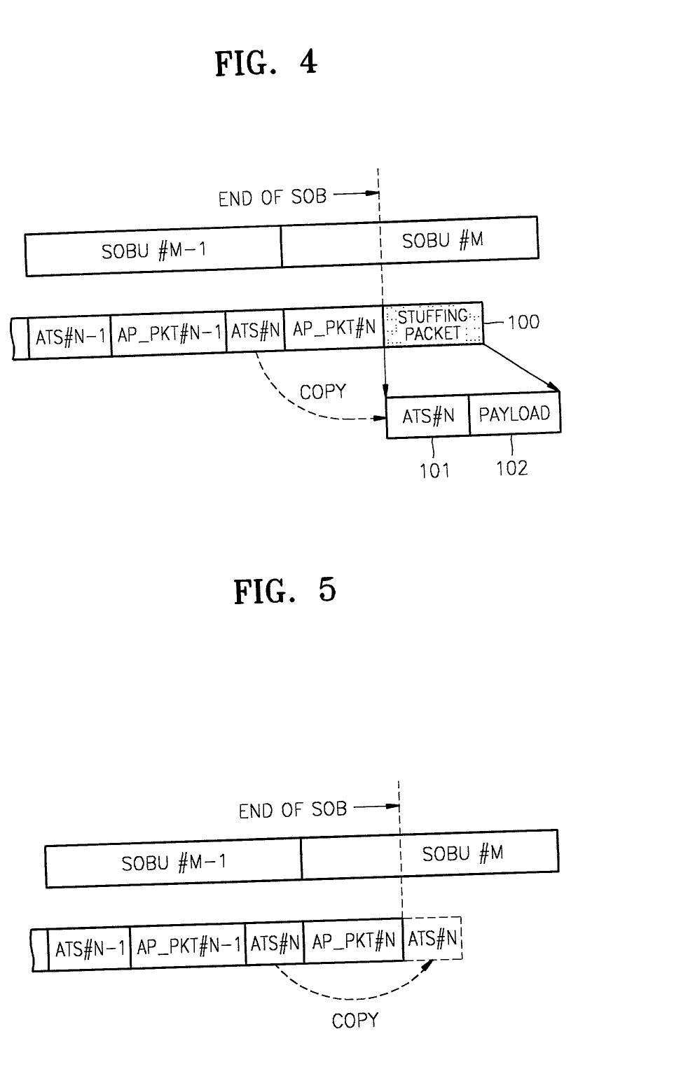

FIG. 4 shows a data structure according to an embodiment of the present invention.

Referring now to FIG. 4, an SOB is formed of an SOBU chain, in which M SOBUs are connected. Each of the M SOBUs, excluding a last SOBU, contains the first byte of each of at least two ATS. SOBU #M−1 contains the first bytes of ATS #N−1 and ATS #N.

SOBU #M does not contain an ATS, but contains all or part of an application packet AP_PKT #N. That is, for example, when there is no ATS contained in the last SOBU, which is SOBU #M, a stuffing packet 100 for correction is recorded after the last application packet AP_PKT #N. The stuffing packet 100 for correction is formed of ATS #N 101 and a payload 102. The ATS contained in the stuffing packet 100 has a value obtained by copying ATS #N attached to AP_PKT #N. In the payload 102, “0” is recorded. Since the SOB ends with the last application packet AP_PKT #N, and data recorded after the last application packet AP_PKT #N is not read in reproducing the SOB, data format and content recorded in the payload 102 may change in various ways when necessary. In some cases, no data may be recorded in the payload 102.

Next, a data structure to make a last SOBU have an IAPAT, according to an embodiment of the present invention will be explained.

FIG. 5 shows a data structure, according to an embodiment of the present invention.

Referring now to FIG. 5, an SOB is formed of an SOBU chain, in which M SOBUs are connected. Each SOBU, excluding last SOBU, contains the first byte of each of at least two ATSs. SOBU #M−1 contains the first bytes of ATS #N−1 and ATS #N.

As described in FIG. 4, the ATS contained in SOBU #M has the same value as the ATS #N attached to AP_PKT #N, but is not actually recorded. That is, for example, in calculating an IAPAT value required for recording a mapping list as search information, ATS #N is read and then is regarded as the ATS of SOBU #M although no ATS is actually contained in SOBU #M. The IAPAT obtained by regarding the ATS #N as the ATS of SOBU #M is recorded in the mapping list as search information.

As described in FIGS. 4 and 5, the first ATS of SOBU #M−1 is ATS #N−1, and the first ATS of SOBU #M is ATS #N. Since the first ATSs are different, the IAPAT of SOBU #M−1 is not “0”. Thus, the IAPAT values of all SOBUs are correctly obtained. Therefore, since each SOBU has an IAPAT value which is distinguished from other IAPATs, program searching referring to a mapping list is performed smoothly without error.

The rule for obtaining an IAPAT is as follows.

For an i-th SOBU (SOBU(i)) excluding SOBU #M, when an SOB contains M SOBUs, a value obtained by accumulating IAPATs from the first IAPAT (IAPAT(1)) to the i-th IAPAT (IAPAT(i)), should be greater than or equal to an arrival time of the first application packet of SOBU(i+1), and less than a value obtained by adding “1” to the arrival time of the first application packet of SOBU(i+1). Thus, an IAPAT has an integer value and the initial value of an IAPAT is “0”. This can be expressed as follows:

SOBU_{—}S_{—}APAT(i+1)≦SUM_{—}IAPAT(i)≦SOBU_{—}S_{—}APAT(i+1)+1

Here, SOBU_S_APAT(i+1) denotes the arrival time of the first application packet contained in SOBU #i+1, and SUM_IAPAT(i) denotes a value obtained by accumulating the IAPATs of SOBU#i and all preceding SOBUs.

Also, as for SOBU #M, a value obtained by accumulating all IAPATs is greater than the arrival time of the last application packet contained in SOBU #M, and less than or equal to a value obtained by adding “1” to the arrival time of the last packet contained in the SOBU #M. This can be expressed as follows:

SOBU_{—}E_{—}APAT(M)≦SUM_{—}IAPAT(M)≦SOBU_{—}E_{—}APAT(M)+1

Here, SOBU_E_APAT(M) denotes the arrival time of the last application packet contained in SOBU #M.

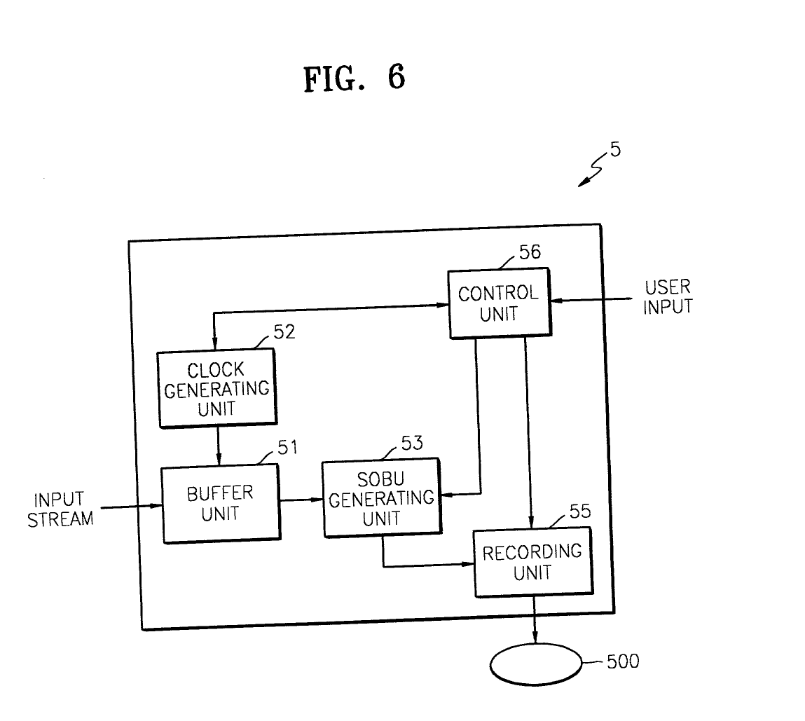

FIG. 6 is a block diagram of a recording apparatus, according an embodiment of the present invention.

Referring now to FIG. 6, the recording apparatus 5 records contents such as music or movies in one SOB having the data structure as described above in FIGS. 4 and 5, and has a buffer unit 51, a clock generating unit 52, an SOBU generating unit 53, a recording unit 55, and a control unit 56. The buffer unit 51 receives content stream data from the outside and outputs the content stream data by buffering the content stream data based on clock values provided from the clock generating unit 52. The SOBU generating unit 53 generates SOBUs by packing the content stream data output from the buffer unit 51. The recording unit 55 records SOBUs and search information such as a mapping list on an recording medium 500 based on controls from the control unit 56. The control unit 56 generates a mapping list and provides the mapping list to the recording unit 55, while controlling the entire recording apparatus 5 so that content stream data is recorded on the recording medium 500.

In view of the structure described above, an embodiment of a recording method according to the present invention is explained below.

When content stream data input to the buffer unit 51 from an application apparatus such as a set-top-box, and a user pushes a recording button (not shown) of the recording apparatus 5, the control unit 56 resets the clock generating unit 52. Then, the clock generating unit 52 generates clock values from “0” and provides the clock values to the buffer unit 51.

The buffer unit 51 attaches the clock values received from the clock generating unit 52 to the received content stream data, and outputs the received content stream data by buffering the content stream data. The SOBU generating unit 53 packs the content stream data received from the buffer unit 51, and generates SOBUs. The generated SOBUs are transmitted to the recording unit 55, and the recording unit 55 records the received SOBUs on the recording medium 500 based on the controls from the control unit 56.

As shown in FIG. 4, if each of the SOBUs contained in the SOB, excluding the last SOBU, contains at least two ATSs and the last SOBU has no ATS, a stuffing packet 100 for correction is recorded continuously after the last application packet AP_PKT #N. As the ATS is contained in the stuffing packet 100 for correction, the preceding ATS #N 101 is copied and then recorded. “0” is recorded in the payload 102.

Also, the recording unit 55 records the mapping list, provided from the control unit 56, as navigation data for searching the recording area of the recording medium 500.

An embodiment of a recording method according to the present invention is explained below.

When content stream data is input to the buffer unit 51 from an application apparatus such as a set-top-box, and a user pushes a recording button (not shown) of the recording apparatus 5, the control unit 56 resets the clock generating unit 52. Then, the clock generating unit 52 generates clock values from “0” and provides the clock values to the buffer unit 51.

The buffer unit 51 attaches the clock values received from the clock generating unit 52 to the received content stream data, and outputs the received content stream data by buffering the content stream data. The SOBU generating unit 53 packs the content stream data received from the buffer unit 51, and generates SOBUs. The generated SOBUs are transmitted to the recording unit 55, and the recording unit 55 records the received SOBUs on the recording medium 500 based on the controls from the control unit 56.

Also, the recording unit 55 records the mapping list, provided from the control unit 56, as navigation data for searching the information recording area of the recording medium 500. Here, the mapping list is generated by the control unit 56 and provided to the recording unit 55. More specifically, as shown in FIG. 5, the control unit 56 reads ATS #N, regards this value as the ATS of SOBU #M, and records an IAPAT value. This is obtained by the rule described above, based on ATS #N in the mapping list. Thus, the ATS of SOBU #M has the same value as ATS #N, but the value is not a value actually recorded as data. For example, the value a virtual value used by the control unit 56 in calculating an IAPAT value forming the mapping list.

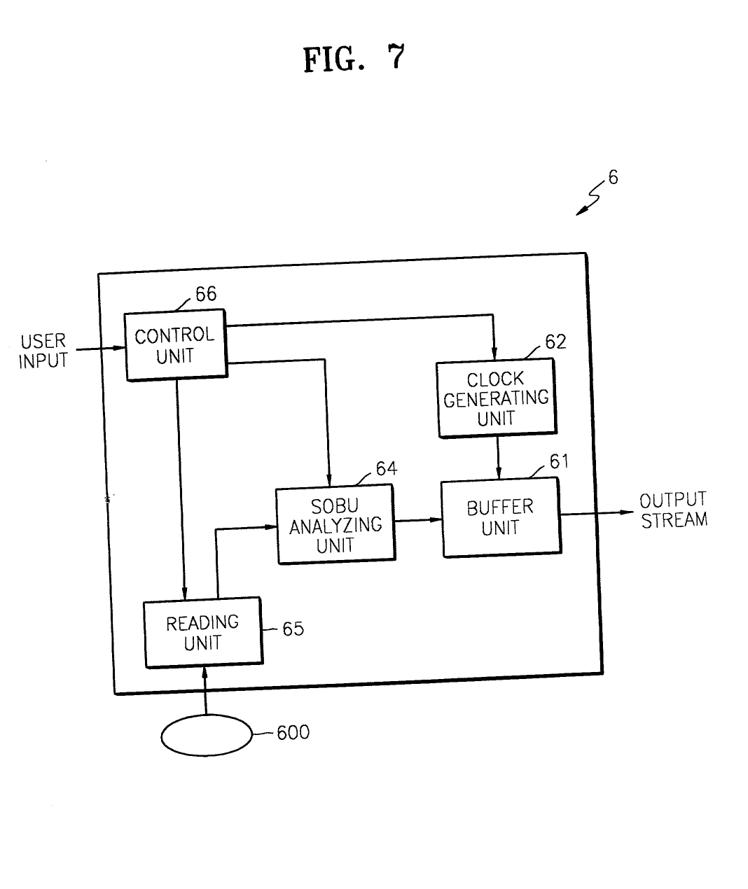

FIG. 7 is a block diagram of a reproducing apparatus, according to an embodiment of the present invention.

Referring now to FIG. 7, the reproducing apparatus 6 reproduces contents from an recording medium 600 on which data having the data structure described in FIGS. 4 through 6, is recorded, and has a control unit 66, a reading unit 65, an SOBU analyzing unit 64, a clock generating unit 62, and a buffer unit 61.

The control unit 66 decodes various control information including a mapping list and controls the entire reproducing apparatus 6 so that contents recorded on the recording medium 600 are reproduced based on user's requirements. The reading unit 65 reads data from the recording medium 600. The SOBU analyzing unit 64 extracts content stream data forming contents by analyzing read SOBUs, and outputs content stream data by buffering content stream data based on the clock values provided from the clock generating unit 62.

In view of the structure described above, an embodiment of a reproducing method according to the present invention is explained below.

If a user requests to reproduce predetermined contents by pushing a reproducing button (not shown) of the reproducing apparatus 6, the control unit 66 commands the reading unit 65 to read search information including a mapping list recorded on the recording medium 600. Received search information including the mapping list, provided from the reading unit 65, is used to find out the corresponding SOB or the corresponding SOBU. As shown in FIG. 4, even if each of the SOBUs contained in the SOB, excluding the last SOBU, has at least two ATSs and the last SOBU has no ATS, a stuffing packet 100 for correction, which contains ATS #N 101, is recorded on the recording medium 600, following the last application packet AP_PKT #N. A mapping list having an IAPAT obtained based on the stuffing packet for correction 100 is recorded as search information. Therefore, searching for contents and reproducing desired contents is smoothly performed.

The control unit 66 resets the clock generating unit 62. Then, the clock generating unit 62 generates clock values from “0” and provides the clock values to the buffer unit 61.

The reading unit 65 reads recorded contents and provides the contents to the SOBU analyzing unit 64. The SOBU analyzing unit 64 extracts content stream data from the provided SOBU. The buffer unit 61 outputs the corresponding content stream data at a time when the clock value provided from the clock generating unit 62 becomes the same as the clock value attached to the received content stream data.

An embodiment of the reproducing method according to the present invention is explained below.

If a user requests to reproduce predetermined contents by pushing a reproducing button (not shown) of the reproducing apparatus, the control unit 66 commands the reading unit 65 to read search information including a mapping list recorded on the recording medium 600. Received search information including the mapping list, provided from the reading unit 65, is used to find out the corresponding SOB or the corresponding SOBU. As shown in FIG. 5, even if each of the SOBUs contained in the SOB, excluding the last SOBU (SOBU #M), has at least two entire ATS and there is no ATS contained in the last SOBU, a mapping list which contains an IAPAT obtained by regarding SOBU #M as having ATS #N is recorded as search information. Therefore, searching for contents and reproducing desired contents is smoothly performed.

The control unit 66 resets the clock generating unit 62. Then, the clock generating unit 62 generates clock values from “0” and provides the clock values to the buffer unit 61.

The reading unit 65 reads recorded contents and provides the contents to the SOBU analyzing unit 64. The SOBU analyzing unit 64 extracts content stream data from the provided SOBU and outputs the corresponding content stream data to the buffer unit 61. The buffer unit 61 outputs the corresponding content stream at a time when the clock value provided from the clock generating unit 62 becomes the same as the clock value attached to the received content stream data.

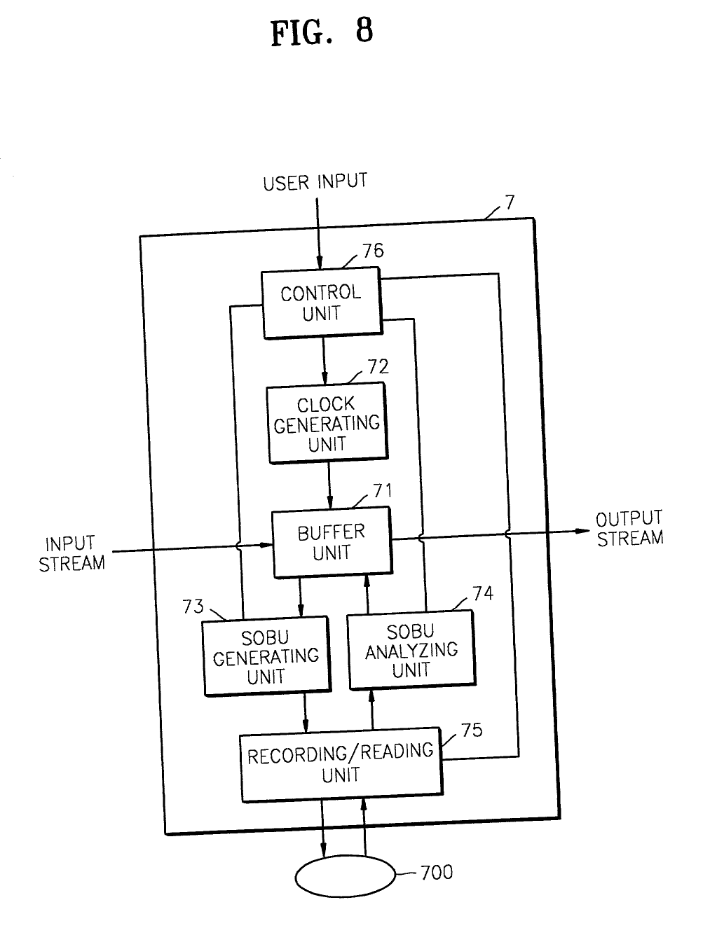

FIG. 8 is a block diagram of a recording and reproducing apparatus, according to an embodiment of the present invention.

Referring now to FIG. 8, the recording and reproducing apparatus 7 is implemented by combining the recording apparatus 5 of FIG. 6 and the reproducing apparatus 6 of FIG. 7 into one unit. The recording and reproducing apparatus has a recording/reading unit 75, an SOBU generating unit 73, an SOBU analyzing unit 74, a buffer unit 71, a clock generating unit 72, and a control unit 76. Thus, for example, in recording, a piece of content such as a music track or a movie is recorded as one SOB having the data structure described above. In reproducing, for example, contents are reproduced from a recording medium 700 on which data having the structure as explained in FIGS. 4 through 6, are recorded.

In recording, the buffer unit 71 receives content stream data from the outside, and outputs the content stream data by buffering the content stream data based on clock values provided from the clock generating unit 72. In reproducing, the buffering unit 71 just outputs content stream data by buffering the content stream data based on clock values provided from the clock generating unit 72.

The SOBU generating unit 73 generates SOBUs by packing content stream data. The SOBU analyzing unit 74 extracts content stream data forming contents by analyzing SOBUs.

In recording, the recording/reading unit 75 records SOBUs and search information such as a mapping list on the recording medium 700, based on control of the control unit 76 and content stream data packed in SOBUs. In reproducing, the recording/reading unit 75 reads search information including a mapping list, or SOBUs recorded on the recording medium 700, at the request of the control unit 76.

In recording, the control unit 76 generates a mapping list and provides the mapping list to the recording/reading unit 75 and thus, controls the entire recording and reproducing apparatus 7 so that content stream data is recorded on the recording medium 700. In reproducing, the control unit 76 decodes various control information including the mapping list, and controls the entire recording and reproducing apparatus, so that contents recorded on the recording medium 700 is reproduced.

The recording and reproducing method of the recording and reproducing apparatus 7, having the structure described above, are the same as those of the above-described recording apparatus and reproducing apparatus, respectively.

According to the methods and apparatuses described above, the IAPAT values of all SOBUs are correctly obtained. Therefore, program searching when referring to a mapping list is smoothly performed without error.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A recording medium on which content stream data is recorded, comprising:
a Stream OBject (SOB) formed with Stream OBject Units ( SOBUs) which has a predetermined size and one or more stream packs,
each of the stream packs having an Application Time Stamp (ATS) indicating reproducing time information and an application packet in which content stream data is packed,
wherein each of the SOBUs, excluding a last SOBU and SOBUs having stuffing packets, includes at least two entire ATSs.

2. The recording medium of claim 1, wherein a size of the application packet is small enough so that the SOBUs, excluding the last SOBU and the SOBUs having stuffing packets, includes at least two entire ATSs.

3. The recording medium of claim 2, wherein the size of the application packet satisfies the following equation:
AP_{—}PKT_{—}SZ≦SPayload_{—}SZ×{SOBU_{—}SZ/2}−{cell((N_{—}AHE+N_{—}SByte)/2)+ATS_{—}SZ},
where AP_PKT_SZ denotes the size of the application packet, ATS_SZ denotes a size of an ATS which is formed in units of bytes, SOBU_SZ denotes a size of an SOBU, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

4. The recording medium of claim 3, wherein the size of the application packet satisfies the following equation:
AP_{—}PKT_{—}SZ≦2018×{SOBU_{—}SZ}−6
where AP_PKT_SZ denotes the size of the application packet and SOBU_SZ denotes the size of the SOBU.

5. The recording medium of claim 4, further comprising:
a MAPping List (MAPL) having an Incremental Application Packet Arrival Time (IAPAT) indicating a duration of the corresponding SOBU as search information indicating which of the SOBUs are included in a corresponding SOB.

6. A recording medium on which content stream data is recorded, comprising:
a Stream OBject (SOB) formed with Stream OBject Units ( SOBUs) which has a predetermined size and one or more stream packs,
each of the stream packs having an Application Time Stamp (ATS) indicating reproducing time information and an application packet in which content stream data is packed,
wherein each of the SOBUs, excluding a last SOBU and SOBUs having stuffing packets, includes at least two entire ATSs,
each of the remaining SOBUs having the stuffing packets for correction include a predetermined ATS.

7. The recording medium of claim 6, wherein the stuffing packets for correction are recorded continuously after a last application packet included in the SOB.

8. The recording medium of claim 7, wherein the predetermined ATS included in the stuffing packet for correction has the same value as an ATS included in the last stream pack.

9. The recording medium of claim 8, wherein the stuffing packet for correction further includes a payload in which predetermined data is recorded or no data is recorded.

10. The recording medium of claim 9, wherein a “0” is recorded in the payload.

11. The recording medium of claim 10, wherein the size of the application packet is small enough so that each of the SOBUs, excluding the last SOBU, includes at least two entire ATS.

12. The recording medium of claim 11, wherein the size of the application packet satisfies the following equation:
AP_{—}PKT_{—}SZ≦SPayload_{—}SZ×{SOBU_{—}SZ/2}−{cell((N_{—}AHE+N_{—}SByte)/2)+ATS_{—}SZ},
where, AP_PKT_SZ denotes the size of the application packet, ATS_SZ denotes a size of an ATS which is formed in units of bytes, SOBU_SZ denotes a size of an SOBU, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

13. The recording medium of claim 12, wherein the size of the application packet satisfies the following equation:
AP_{—}PKT_{—}SZ≦2018×{SOBU_{—}SZ/2}−6,
where AP_PKT_SZ denotes the size of the application packet and SOBU_SZ denotes the size of the SOBU.

14. The recording medium of claim 13, further comprising:
a MAPping List (MAPL) having an Incremental Application Packet Arrival Time (IAPAT) indicating a duration of the corresponding SOBU as search information indicating which of the SOBUs are included in a corresponding SOB.

15. A recording apparatus to record content stream data as a Stream OBject (SOB) formed with at least one Stream OBject Unit (SOBU) having a predetermined size and one or more stream packs, each of the stream packs having an Application Time Stamp indicating reproducing time information and an application packet in which content stream data is packed, the recording apparatus comprising:
a control unit that generates a mapping list as search information;
a clock generation unit that generates a clock value;
a buffer unit that attaches the clock value provided from said clock generating unit to received content stream data, and outputs the received content stream data by buffering the content stream data;
a stream object unit (SOBU) generating unit which packs the received content stream data output from said buffer unit and generates SOBUs so that each of the SOBUs, excluding a last SOBU, contains at least two entire Application Time Stamps (ATSs); and
a recording unit which records the SOBUs generated by said SOBU generating unit and the mapping list generated by said control unit.

16. The recording apparatus of claim 15, wherein a size of the application packet is small enough so that each of the SOBUs, excluding the last SOBU, includes at least two entire ATSs.

17. The recording apparatus of claim 16, wherein the size of the application packet satisfies the following equation:
AP_{—}PKT_{—}SZ≦SPayload_{—}SZ×{SOBU_{—}SZ/2}−{cell((N_{—}AHE+N_{—}SByte)/2)+ATS_{—}SZ},
where AP_PKT_SZ denotes the size of the application packet, ATS_SZ denotes a size of an ATS which is formed in units of bytes, SOBU_SZ denotes size of an SOBU, SPayload_SZ denotes a size of a data space containing information excluding a fixed header area of a stream pack, N_AHE denotes a number of application header extensions of a corresponding SOBU, and N_SByte denotes a number of stuffing bytes of a corresponding SOBU.

18. The recording apparatus of claim 17, wherein the size of the application packet satisfies the following inequality:
AP_{—}PKT_{—}SZ≦2018×{SOBU_{—}SZ/2}−6,
where AP_PKT_SZ denotes the size of the application packet and SOBU_SZ denotes the size of the SOBU.

19. The recording apparatus of claim 18, wherein a MAPping List (MAPL) having an Incremental Application Packet Arrival Time (IAPAT) indicating a duration of the corresponding SOBU is included as search information indicating which of the SOBUs are included in a corresponding SOB.

20. A recording apparatus for recording content stream data as a Stream OBject (SOB) formed with at least one Stream OBject Unit (SOBU) having a predetermined size, the recording apparatus comprising:
a control unit that generates a mapping list as search information;
a clock generation unit that generates a clock value;
a buffer unit attaching the clock value provided from said clock generating unit to received content stream data, and outputting the received content stream data by buffering the content stream data;
a stream object unit (SOBU) generating unit which inserts a stuffing packet for correction having a predetermined Application Time Stamp (ATS) which has a value the same as an ATS among ATSs included in an SOBU located immediately before one of the SOBUs having no corresponding ATS; and
a recording unit which records the SOBUs generated by said SOBU generating unit and the mapping list generated by said control unit.

21. The recording apparatus of claim 20, wherein all SOBUs, excluding a last SOBU, have at least two entire ATSs.

22. The recording apparatus of claim 21, wherein said SOBU generating unit includes a stuffing packet for correction in the last SOBU.

23. The recording apparatus of claim 22, wherein the recording unit continuously records the stuffing packet after a last one of the application packets included in the SOB.

24. The recording apparatus of claim 23, wherein an ATS included in the stuffing packet for correction has a same value as an ATS included in a last stream pack of the SOBUs.

25. The recording apparatus of claim 24, wherein the stuffing packet for correction further includes a payload in which predetermined data is recorded or no data is recorded.

26. The recording apparatus of claim 25, wherein a “0” is recorded in the payload.

27. A recording apparatus to record an Stream OBject (SOB) having one or more Stream OBject Units (SOBUs), each of the SOBUs has one or more stream packs arrayed in a row and divided into units of a predetermined size and sequentially assigned, each of the stream packs having an Application Time Stamp (ATS) and an application packet in which content stream data is packed, the recording apparatus comprising:
a clock generation unit to generate a clock value;
a buffer unit to attach the clock value provided from said clock generating unit to received content stream data, and to output the received content stream data;
a stream object unit (SOBU) generating unit to generate SOBUs by packing the received content stream data output from said buffer unit;
a control unit to generate a mapping list as search information by regarding a last one of the SOBUs which has no corresponding ATS as having a virtual ATS; and
a recording unit to record the SOBUs generated by said SOBU generating unit and the mapping list generated by said control unit.

28. The recording apparatus of claim 27, wherein said control unit generates a mapping list having an incremental application packet arrival time (IAPAT) obtained by regarding a last application packet included in the SOB as having a virtual ATS.

29. A reproducing apparatus to reproduce content stream data from a recording medium on which content stream data is recorded as an Stream OBject (SOB) formed with at least one Stream OBject Unit (SOBU) having a predetermined size and one or more stream packs, each of the stream packs having an Application Time Stamp (ATS) indicating reproducing time information and an application packet in which content stream data is packed, each of the SOBUs, excluding a last SOBU and SOBUs having stuffing packets, includes at least two entire ATSs, the reproducing apparatus comprising:
a reading unit to read a mapping list as search information and a corresponding SOBU, where the mapping list has search information generated by regarding the last SOBU as an SOBU having a virtual ATS;
a control unit to control the reading unit to read the corresponding SOBU, referring to the mapping list read by the reading unit;
a clock generating unit to generate a clock value;
an SOBU analyzing unit to extract content stream data by analyzing the SOBU read by said reading unit; and
a buffering unit to output the content stream data from the SOBU analyzing unit by buffering the content stream data based on a clock value provided by said clock generating unit.

30. The reproducing apparatus of claim 29, wherein the mapping list includes an incremental application packet arrival time (IAPAT) indicating a duration of the corresponding SOBU as search information indicating a corresponding SOBU of a corresponding SOB.

31. The reproducing apparatus of claim 30, wherein an ATS included in the stuffing packet for correction is a predetermined ATS and has the same value as an ATS included in a last stream pack of the SOBUs.

32. The reproducing apparatus of claim 31, wherein the stuffing packet for correction further includes a payload in which predetermined data is recorded or no data is recorded.

33. An apparatus comprising:
a recording apparatus to record a stream object formed with at least one stream object units (SOBUs) in which content stream data having one or more stream packs are recorded, each of the stream packs including an application packet having an application time stamp and the content stream data packed therein, said recording apparatus including:
a recording control unit to generate a mapping list as search information;
a clock generation unit to generate a clock value;
a buffer unit to buffer input content stream data, to add the clock value provided by the clock generation unit to the input content stream data, and to output a result;
a Stream Object Unit (SOBU) generating unit to generate the SOBUs, each of the SOBUs, excluding a last one of the SOBUs and SOBUs having stuffing packets, includes at least two entire ATSs; and
a recording unit to record the plurality of generated SOBUs and the mapping list on a recordable recording medium; and
a reproducing apparatus to reproduce data from a reproduceable recording medium, the reproducing apparatus including:
a reading unit to read the mapping list as search information; and
a reproducing control unit to search for a corresponding SOBU by referring to a generated search information and regarding a value of the predetermined application time stamp as the value of an application time stamp for the last one of the SOBUs in the stream object when referring to the read mapping list.
